(19) United States
(12) Patent Application Publication
(10) Pub. No.: US 2011/0238444 A1
(43) Pub. Date: Sep. 29, 2011

(54) SYSTEM FOR PROCESSING MEDICAL RECORDINGS PLUS METHOD

(75) Inventor: Andreas Klingler, Rottenbach (DE)

(73) Assignee: SIEMENS AKTIENGESELLSCHAFT, Munich (DE)

(21) Appl. No.: 13/053,367

(22) Filed: Mar. 22, 2011

(30) Foreign Application Priority Data
Mar. 25, 2010 (DE) 10 2010 012 796.5

(51) Int. Cl. G06Q 50/00; G06Q 10/00

(52) U.S. Cl. 705/3

(57) ABSTRACT

A system is disclosed, in at least one embodiment, for processing medical recordings including at least one device for receiving at least one current medical recording of a patient from a medical imaging system as well as at least one device for receiving from a memory at least one medical recording or study which was taken during a previous examination and assigned to the patient. Furthermore, at least one device is provided for comparing the current medical recording to the medical recording or study taken during the previous examination as well as at least one device for determining an estimated figure for the probability with which both recordings originate from the same patient. At least one embodiment of the inventive system for processing medical recordings further has at least one device for issuing a warning message to the imaging medical system which is displayed there to an operator of the imaging medical system if the estimated probability figure undershoots a threshold value.

### PRIORITY STATEMENT

The present application hereby claims priority under 35 U.S.C. §119 on German patent application number DE 10 2010 012 796.5 filed Mar. 25, 2010, the entire contents of which are hereby incorporated herein by reference.

### FIELD

At least one embodiment of the present invention generally relates to a system for processing medical recordings. In particular, at least one embodiment of the present invention relates to a system and/or method for preventing medical recordings from being incorrectly assigned to patients.

### BACKGROUND

When taking medical recordings of patients using medical imaging systems such as computed tomographs or nuclear spin tomographs it occasionally happens in practice that the wrong patient is examined. There are a number of possible reasons for this: hard-of-hearing or non-hearing patients turn up after registering for the examination itself, without having been called; radiology support staff get patients mixed up either when recording the image or when saving the data, or they save the data under a similar name (e.g. in the file of a patient called Davis instead of in the file of a patient called Davies); emergency patients are slotted into a pre-arranged sequence, resulting in the scheduling and the correct assignment of recordings to patients getting muddled up.

These incorrect assignments should always be avoided. Even if an incorrect assignment is noticed, in the best-case scenario it results in extra work for the hospital's IT department, where an employee will spend a lot of time correcting the incorrect assignment manually, a task which moreover is very prone to error. In many cases it is not possible to reconstruct the mix-up retrospectively. It may then even be necessary to take the recordings again, thereby not only incurring unnecessary costs but also exposing the patient to another unnecessary dose of radiation. And finally on occasion it can happen that incorrect assignments are not noticed until very late on (e.g. after an operation has already been scheduled) or even not at all, which may result in considerable extra costs, and incorrect treatment or no treatment at all being given.

### SUMMARY

In at least one embodiment of the present invention, a system is provided for processing medical recordings which prevents medical recordings being incorrectly assigned to patients.

In at least one embodiment of the invention, a system is disclosed for processing medical recordings which includes at least one device for receiving at least one current medical recording of a patient from a medical imaging system as well as at least one device for receiving from a memory at least one medical recording or study which was taken during a previous examination and assigned to the patient. Furthermore, at least one device is provided for comparing the current medical recording to the medical recording or study taken during the previous examination as well as at least one device for determining an estimated figure for the probability with which both recordings originate from the same patient. The inventive system for processing medical recordings of at least one embodiment furthermore includes at least one device for issuing a warning message to the imaging medical system which is displayed there to an operator of the imaging medical system if the estimated probability figure undershoots a threshold value. Alternatively, instead of the current recording and the recording or study taken during the previous examination, fingerprints are used; these represent the recordings, but take up less memory space.

Such a system supports and improves the workflow when taking medical recordings, in that new recordings of a patient are automatically compared to prior studies, in other words recordings and findings taken previously, and a warning is generated and is issued to the operator soon after the recording if the comparison shows that the probability that the recordings originate from the same patient undershoots a threshold value. The operator is thus automatically warned in cases of doubt after the new recording is taken and can check the identity of the patient just examined, and then confirm or correct it.

In this way, at least in cases in which sufficient material from prior studies already exists, an incorrect assignment of new recordings to a patient can be better prevented.

Advantageously, the recordings of the patient taken during the previous examination are loaded into a local memory by at least one embodiment of the inventive system for processing medical recordings before the current medical recording is created. This measure improves the realtime capability of the system, especially where there is voluminous material from prior studies, since retrieving voluminous material from a PACS (Picture Archiving and Communication System) or similar (long-term) memories can take some time.

Also the subject of at least one embodiment of the invention is a medical imaging system into which a system for processing medical recordings of the aforementioned type can be integrated.

At least one embodiment of the invention further relates to a method which can run in a medical imaging system or a system for processing medical recordings and which serves to prevent incorrect assignments of medical recordings to patients.

### DETAILED DESCRIPTION OF THE EXAMPLE EMBODIMENTS

Various example embodiments will now be described more fully. Specific structural and functional details disclosed herein are merely representative for purposes of describing example embodiments. The present invention, however, may be embodied in many alternate forms and should not be construed as limited to only the example embodiments set forth herein.

Accordingly, while example embodiments of the invention are capable of various modifications and alternative forms, it should be understood, however, that there is no intent to limit example embodiments of the present invention to the particular forms disclosed. On the contrary, example embodiments are to cover all modifications, equivalents, and alternatives falling within the scope of the invention.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments of the invention. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted.

Spatially relative terms, such as “beneath”, “below”, “lower”, “above”, “upper”, and the like, may be used herein for ease of description to describe one element or feature's relationship to another element(s) or feature(s). It will be understood that the spatially relative terms are intended to encompass different orientations of the device in use or operation. Thus, term such as “below” can encompass both an orientation of above and below. The device may be otherwise oriented (rotated 90 degrees or at other orientations) and the spatially relative descriptors used herein are interpreted accordingly.

Although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the teachings of the present invention.

In the following, example embodiments of the present invention are explained in greater detail.

In a first exemplary embodiment, a system for processing medical recordings, for example a workstation or a computer that can be specially programmed for image processing, is equipped with interface and software segments/modules for receiving at least one current medical recording of a patient from a medical imaging system. Suitable interface device(s) are well known to the person skilled in the art as regards both their physical design and their communication protocols. For example, the link between the system for processing medical recordings and the medical imaging system can be effected by way of an Ethernet network, via which communication is effected in accordance with the communication protocol of the DICOM standard.

Furthermore, the system for processing medical recordings is equipped with interface and software segments/modules for receiving prior study material, especially medical recordings taken during previous examinations and assigned to the patient, from a PACS or a similar bulk storage device connected to a network. Here the same or similar interface device(s) as described above can be used.

Software programs/segments/modules of the system for processing medical recordings control the interface device(s) and supply the received data (current recording, previous recording(s)). Advantageously the data concerning the prior studies of the patient is loaded beforehand into a local memory, since transferring voluminous prior studies can take some time.

Preferably, previous recordings included in the prior studies that are not suitable for comparison with the (planned) current recording are not loaded into the local memory in this case. For example, it is unnecessary to load x-ray images of the extremities present in the prior studies if a recording of the thorax is currently being planned, as a comparison of these recordings will generally not produce usable results in terms of an embodiment of the present invention.

The software segments/modules compare the current medical recording with the prior studies material—within the boundaries set by the prior studies material. To this end the software segments/modules use header information from the recordings to be compared, where this is present, in order to prepare as large areas as possible of the recordings to be compared for the comparison. In practice it will be difficult or impossible to take the current recording with an image section and recording parameters that are identical to those in a recording already present in the prior studies material. In some cases, namely if no change is expected in the image section, this situation is even systematically avoided.

This is why the software segments/modules contain powerful image processing modules with which a forecast is derived from the prior studies material of what the recording currently planned might look like. This can be achieved for example as a function of the existing prior studies material and the planned recording, in that existing 3D material is reduced onto the 2D section that is currently to be recorded, or in that existing 2D recordings are assembled, rotated along the spatial axes, stretched and/or compressed, and/or in that a 2D recording is interpolated, from existing 2D recordings in a given mapping plane, in the currently planned mapping plane which deviates therefrom.

The forecast of what the currently planned recording might look like is then compared to the current recording, and from the degree of match a value is calculated indicating the probability with which both recordings originate from the same patient. If the degree of match is high, the probability that this relates to the same patient is likewise high. In contrast, if the degree of match is low or if no matches at all can be determined in crucial features of the recording, the probability is low that these are recordings of the same patient.

Advantageously, when calculating the said probability figure, account can be taken of how reliable the forecast of what the currently planned recording might look like is. In some cases the reliability of the forecast will be low, because many crucial features of the recording had to be interpolated, so that a low match with the current recording does not permit any conclusion to be drawn as to whether these are recordings of the same patient. In these cases it makes no sense to output the probability figure. Instead, an indicator can be generated stating that it is not possible to automatically assess the specific situation.

A warning message can be issued, via the aforementioned (or separate) interface device(s), to the imaging medical system and can be displayed there to an operator of the imaging medical system if the estimated probability figure undershoots a threshold value. In this case the threshold value can be made configurable, for example in order to be able to reduce an excessively high error alarm rate. Instead of the warning message the aforementioned indicator can be displayed, pointing out that no automatic assessment is possible. Alternatively, in addition to the warning a numerical value can be output which reflects the reliability of the automatic assessment. In a further alternative the display of the warning and/or of the reliability figure can be effected directly at the system for processing medical recordings.

All outputs are effected in an example embodiment of the present invention at an operating console of the imaging system.

In a further example embodiment the system for processing medical recordings described in detail above is integrated into a medical imaging system, e.g. into a computed tomography system or a magnetic resonance system. This is particularly advantageous for new imaging systems, since such an imaging system presents a uniform aspect to the operator.

In contrast, the standalone version of the system for processing medical recordings described in detail is especially suitable for retrofitting imaging systems already installed.

In further embodiments of the invention the previous recordings or studies can be preprocessed by an image management system or a workflow control system (RIS) to create “fingerprints” and then transferred to the system for processing medical recordings or the operating console, where the fingerprints are compared to the current recordings or to fingerprints of the current recordings. In particular, such fingerprints can be calculated as standard for each new recording and can be saved, meaning that they do not have to be calculated first for the comparison step of an embodiment of the present invention. These fingerprints can be saved in addition to the normal demographic patient data for the different types of recording and can be sent together with the order to the imaging and/or the image-processing system, where they are compared to the new recordings. For a system such as this the full, generally very voluminous prior studies do not need to be loaded at all by the image-processing system; it is sufficient to load the fingerprints, so that instead of a high data volume only a small data volume has to be transferred.

For the fingerprints, parameters characteristic of the patient are calculated from the current and previous recordings. Similarly to face recognition, for which for example head shape and ratio of the spacings of eyes, nose and mouth to one another are used to identify a person, characteristic picture elements are used to generate the fingerprints. For example, if it is known from a calculation from a previous recording or study that the patient's femur is 50 cm long, a new recording showing a femur that is 40 cm long cannot originate from the same patient. Furthermore, information about the presence of implants which should be visible on medical recordings can be used to generate the fingerprints. Finally, age-related changes in the patient can be forecast—at any rate with a certain reliability—and included in the comparison of the recordings or the fingerprints, since the date of the current recording and the date of the previous recordings are known.

In other embodiments of the invention the warning message can be issued on a separate terminal or screen. In this case the warning message is not transferred to the imaging system, but is displayed directly by the system for processing medical recordings at this terminal or screen.

The patent claims filed with the application are formulation proposals without prejudice for obtaining more extensive patent protection. The applicant reserves the right to claim even further combinations of features previously disclosed only in the description and/or drawings.

The example embodiment or each example embodiment should not be understood as a restriction of the invention. Rather, numerous variations and modifications are possible in the context of the present disclosure, in particular those variants and combinations which can be inferred by the person skilled in the art with regard to achieving the object for example by combination or modification of individual features or elements or method steps that are described in connection with the general or specific part of the description and are contained in the claims and/or the drawings, and, by way of combineable features, lead to a new subject matter or to new method steps or sequences of method steps, including insofar as they concern production, testing and operating methods.

References back that are used in dependent claims indicate the further embodiment of the subject matter of the main claim by way of the features of the respective dependent claim; they should not be understood as dispensing with obtaining independent protection of the subject matter for the combinations of features in the referred-back dependent claims. Furthermore, with regard to interpreting the claims, where a feature is concretized in more specific detail in a subordinate claim, it should be assumed that such a restriction is not present in the respective preceding claims.

Since the subject matter of the dependent claims in relation to the prior art on the priority date may form separate and independent inventions, the applicant reserves the right to make them the subject matter of independent claims or divisional declarations. They may furthermore also contain independent inventions which have a configuration that is independent of the subject matters of the preceding dependent claims.

Further, elements and/or features of different example embodiments may be combined with each other and/or substituted for each other within the scope of this disclosure and appended claims.

Still further, any one of the above-described and other example features of the present invention may be embodied in the form of an apparatus, method, system, computer program, non-transitory computer readable medium and non-transitory computer program product. For example, of the aforementioned methods may be embodied in the form of a system or device, including, but not limited to, any of the structure for performing the methodology illustrated in the drawings.

Even further, any of the aforementioned methods may be embodied in the form of a program. The program may be stored on a non-transitory computer readable medium and is adapted to perform any one of the aforementioned methods when run on a computer device (a device including a processor). Thus, the non-transitory storage medium or non-transitory computer readable medium, is adapted to store information and is adapted to interact with a data processing facility or computer device to execute the program of any of the above mentioned embodiments and/or to perform the method of any of the above mentioned embodiments.

The non-transitory computer readable medium or non-transitory storage medium may be a built-in medium installed inside a computer device main body or a removable non-transitory transitory medium arranged so that it can be separated from the computer device main body. Examples of the built-in non-transitory medium include, but are not limited to, rewriteable non-volatile memories, such as ROMs and flash memories, and hard disks. Examples of the removable non-transitory medium include, but are not limited to, optical storage media such as CD-ROMs and DVDs; magneto-optical storage media, such as MOs; magnetism storage media, including but not limited to floppy disks (trademark), cassette tapes, and removable hard disks; media with a built-in rewriteable non-volatile memory, including but not limited to memory cards; and media with a built-in ROM, including but not limited to ROM cassettes; etc. Furthermore, various information regarding stored images, for example, property information, may be stored in any other form, or it may be provided in other ways.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A system for processing medical recordings, comprising:
at least one device for receiving at least one current medical recording of a patient from a medical imaging system;
at least one device for receiving from a memory at least one medical recording or study which was taken during a previous examination and assigned to the patient;
at least one device for comparing the current medical recording with the medical recording or study taken during the previous examination;
at least one device for determining an estimated figure for the probability with which both recordings originate from the same patient; and
at least one device for issuing a warning message to the imaging medical system, which is displayed there to an operator of the imaging medical system if the estimated probability figure undershoots a threshold value.

2. The system for processing medical recordings as claimed in claim 1, wherein the recording or study of the patient taken during the previous examination is loaded into a local memory of the system for processing medical recordings before the current medical recording is created.

3. The system for processing medical recordings as claimed in claim 1, wherein the current medical recording is received from a computed tomography system or a magnetic resonance system or a digital x-ray system or a mammography system.

4. A medical imaging system, comprising a system for processing medical recordings according to claim 1.

5. A system for processing medical recordings, comprising:
at least one device for receiving at least one current medical recording of a patient from a medical imaging system;
at least one device for creating a fingerprint of the current medical recording of the patient;
at least one device for receiving from a memory at least one fingerprint of a medical recording or study which was taken during a previous examination and assigned to the patient, and which characterizes the medical recording or study which was taken during the previous examination and assigned to the patient;
at least one device for comparing the fingerprint of the current medical recording to the fingerprint of the medical recording or study taken during the previous examination;
at least one device for determining an estimated figure for the probability with which both recordings originate from the same patient; and
at least one device for issuing a warning message to the imaging medical system, which is displayed there to an operator of the imaging medical system if the estimated probability figure undershoots a threshold value.

6. The system for processing medical recordings as claimed in claim 1, wherein the current medical recording is received from a computed tomography system or a magnetic resonance system or a digital x-ray system or a mammography system.

7. A medical imaging system, comprising a system for processing medical recordings according to claim 5.

8. A method for preventing incorrect assignments of medical recordings to patients, comprising:
receiving at least one current medical recording of a patient from a medical imaging system;
receiving from a memory at least one recording or study which was taken during a previous examination and assigned to the patient;
comparing the current medical recording to the medical recording or study taken during the previous examination;
determining an estimated figure for the probability with which both recordings originate from the same patient; and
issuing a warning message to the imaging medical system which is displayed there to an operator of the imaging medical system if the estimated probability figure undershoots a threshold value.

9. The method as claimed in claim 8, wherein the recording or study of the patient taken during the previous examination is loaded into a local memory of the system for processing medical recordings before the current medical recording is created.

10. The method as claimed in claim 8, wherein the current medical recording is received from a computed tomography system or a magnetic resonance system or a digital x-ray system or a mammography system.

11. A method for preventing incorrect assignments of medical recordings to patients, the method comprising:
receiving at least one current medical recording of a patient from a medical imaging system;
creating a fingerprint of the current medical recording of the patient;
receiving from a memory at least one fingerprint of a medical recording or study which was taken during a previous examination and assigned to the patient, and which characterizes the medical recording or study which was taken during the previous examination and assigned to the patient;
comparing the fingerprint of the current medical recording to the fingerprint of the medical recording or study taken during the previous examination;
determining an estimated figure for the probability with which both recordings originate from the same patient; and
issuing a warning message to the imaging medical system, which is displayed there to an operator of the imaging medical system if the estimated probability figure undershoots a threshold value.

12. The method as claimed in claim 11, wherein the current medical recording is received from a computed tomography system or a magnetic resonance system or a digital x-ray system or a mammography system.

13. The method as claimed in claim 9, wherein the current medical recording is received from a computed tomography system or a magnetic resonance system or a digital x-ray system or a mammography system.

14. A non-transitory computer readable medium including program segments for, when executed on a computer device, causing the computer device to implement the method of claim 8.

15. A non-transitory computer readable medium including program segments for, when executed on a computer device, causing the computer device to implement the method of claim 11.
